(19) United States
(12) Patent Application Publication
(10) Pub. No.: US 2004/0048024 A1
(43) Pub. Date: Mar. 11, 2004

(54) Adhesive layers and release liners with pyramidal structures

(75) Inventors: Danny L. Fleming, Stillwater, MN (US); Frank T. Sher, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/610,005

(22) Filed: Jun. 30, 2003

Related U.S. Application Data
(63) Continuation of application No. 09/808,636, filed on Mar. 14, 2001, now abandoned.

(51) Int. Cl. B32B 9/00

(52) U.S. Cl. 428/40.1; 156/247

(57) ABSTRACT

A release liner with a surface including an array of pyramidal depressions thereon, wherein the depressions are capable of adhering to a handling tape at rate of greater than about 10 g per 2 inch width, as measured by a Handling Tape to Liner Peel Adhesion Test.

### TECHNICAL FIELD

This invention relates to articles that include a structured adhesive layer. The adhesive layers have modified surface geometry that enhances fluid egress when the article is applied to a substrate. The corresponding surface geometry of an optional release liner adjacent the adhesive layer allows handling tapes to more readily adhere to the liner as the article is adhered to the substrate.

### BACKGROUND

The adhesive backed graphic articles described in U.S. Pat. No. 5,897,930, WO 98/29516, WO 00/69985, and U.S. Ser. Nos. 09/311,101, 09/638,346 and 09/639,244 include an adhesive layer with a plurality of recessed interconnecting microchannels. A typical article 10 of this type is shown in FIG. 1, and includes a film 12 having opposed surfaces 14 and 16. The surface 14 of the film 12 is imaged to form a graphic 13. A layer of a pressure sensitive adhesive 18 is bonded to the surface 16 of the film 12. The pressure sensitive adhesive 18 includes a surface 20 that can be bonded to a substrate. The pressure sensitive adhesive 18 includes structures 22 that define a network of channels 24. A release liner 26 is releasably attached to the pressure sensitive adhesive 18. The release liner 26 includes protrusions 28 that form the corresponding channels 24 and structures 22 in the pressure sensitive adhesive 18. The release liner 26, shown in a partially removed state, is fully detachable when pulled in the direction of arrow A and is used to protect the pressure sensitive adhesive prior to application of the article 10 on a substrate.

The geometry and spacing of the protrusions 28 on the release liner 26 should be selected to reduce or prevent fluid entrapment beneath the adhesive as it is rapidly coated onto the release liner during manufacture. The entrapped air can degrade the performance of the coated adhesive layer and reduce the appearance and printability of the film layer, particularly for high-resolution images. Defects caused by the entrapped air detract from the overall appearance of products based on the adhesive backed articles, and the reduced coating speeds required to prevent air entrapment increase production costs.

The shape of the protrusions 28 in the release liner 26 and the corresponding channels 24 in the adhesive layer 18 should be selected to maintain the appearance of the article following adhesion to a substrate, and to allow egress of fluids trapped under the article as it is positioned on and applied to a substrate. Fluid egress allows the adhesive backed article to be repositioned and smoothly applied to the substrate.

If a release liner includes a network of continuous ridges spaced closely together (See 28 in FIG. 1), only a relatively small surface area on the tops of the ridges is available for bonding to a pre-mask, a pre-space, or a splicing tape. The closely spaced ridges also make it more difficult for the tapes to contact and adhere to the relatively flat land areas between the ridges. The shape and spacing of the protrusions 28 should be selected such that pre-mask, pre-space or splicing tapes adhere sufficiently to the release liner to allow transfer of the graphic article into proper registration with a substrate.

One network of structures is a regular pattern of square pyramidal depressions in the release liner or raised protrusions in a corresponding coated adhesive layer. The pyramids have a nominal sidewall angle of 10 degrees with respect to a plane of the release liner or adhesive layer, and a depth in the release liner or height above the adhesive layer of up to about 15 microns. The resulting adhesive layer has insufficient fluid egress at room temperature, and this insufficiency is particularly acute when the adhesive layer is applied to a substrate at an elevated temperature. Application of adhesive backed conformable film articles under typical conditions, using a plastic squeegee at room temperature and up to 40° C. and higher, can result in excessive deformation of the pyramidal structure as the adhesive layer is pressed against the substrate. This deformation prematurely blocks the routes of fluid egress through the adhesive layer, which results in fluid entrapment, bubble formation and insufficient application performance.

### SUMMARY

The release liners of the invention include recessed structures that create mirror image protruding structures on an adjacent adhesive layer. The recessed structures on the release liner are shaped and spaced to provide enhanced coatability and adhesion to handling tapes. The corresponding protruding structures on the adhesive layer are shaped and spaced to provide improved fluid egress when the adhesive layer is adhered to a substrate, particularly at high temperatures, and do not compromise the appearance of the final article.

In a first embodiment, the invention is a release liner having a surface with an array of pyramidal depressions thereon. The pyramidal depressions are capable of adhering to a handling tape at rate of greater than about 10 g per 2 inch width, as measured by a Handling Tape to Liner Peel Adhesion Test described herein. The pyramidal depressions preferably extend downward from a plane of the surface of the release liner to a depth of greater than 15 microns and less than 35 microns. The pyramidal depressions preferably have at least one sidewall that makes an angle of greater than 5° and less than 40° with respect to the plane of the surface of the release liner.

In a second embodiment, the invention is an adhesive backed article that includes a release liner having a surface with pyramidal depressions thereon. The depressions extend downward from a plane of the surface of the release liner to a depth of greater than 15 microns and less than 35 microns, and have at least one sidewall that makes an angle of greater than about 5° and less than about 40° with respect to the plane of the surface. The adhesive backed article further includes an adhesive layer on the surface of the release liner.

In a third embodiment, the invention is an adhesive layer with an array of pyramidal protrusions thereon. The pyramidal protrusions are capable of providing fluid egress of greater than about 20 ml/min at 23° C. at a pressure of 40 inches of water, and greater than about 10 ml/min at 35° C. at a pressure of 40 inches of water, as measured according to the Air Flow Test described herein. Preferably, the protrusions extend upward from a plane of the surface to a height of greater than 15 microns and less than 35 microns. The protrusions preferably have at least one sidewall that makes an angle of greater than 5° and less than 40° with respect to the plane of the surface.

In a fourth embodiment, the invention is a graphic article having an adhesive layer with a surface including pyramidal protrusions. The protrusions extend upward from a plane of the surface to a height of greater than 15 microns and less than 35 microns, and the protrusions have at least one sidewall that makes an angle of greater than 5° and less than 40° with respect to the plane of the surface. The graphic article further includes a imageable film on a surface of the adhesive layer. The graphic article may include an optional release liner on a surface of the adhesive layer opposite the film.

In a fifth embodiment, the invention is a method for contacting the graphic article with a substrate. The method includes providing a graphic article having an adhesive layer with a surface with pyramidal protrusions thereon. The protrusions extend upward from a plane of the surface to a height of greater than 15 microns and less than 35 microns, and have at least one sidewall that makes an angle of greater than 5° and less than 40° with respect to the plane of the surface. The graphic article includes an imageable film on a surface of the adhesive layer. The adhesive layer is contacted with a substrate.

In a sixth embodiment, the invention is a method of enhancing the adhesion of a tape to a release liner. The release liner includes a surface with pyramidal depressions therein. The depressions extend downward from a plane of the surface of the release liner to a depth of greater than 15 microns and less than 35 microns, and have at least one sidewall that makes an angle of greater than about 5° and less than about 40° with respect to the plane of the surface.

In a seventh embodiment, the invention is a method of transferring an adhesive backed article with a release liner and an adhesive layer on the release liner. The method includes attaching a tape to the release liner, wherein the release liner has a surface with pyramidal depressions thereon. The depressions extend downward from a plane of the surface of the release liner to a depth of greater than 15 microns and less than 35 microns, and have at least one sidewall that makes an angle of greater than about 5° and less than about 40° with respect to the plane of the surface.

In an eighth embodiment, the invention is a method of transferring a graphic article. The method includes providing a graphic article including a film with a first surface and a second surface, wherein an image occupies at least a portion of the first surface, an adhesive layer on the second surface of the film, and a release liner on the adhesive layer. The release liner has a surface with pyramidal depressions thereon. The depressions extend downward from a plane of the surface of the release liner to a depth of greater than 15 microns and less than 35 microns, and have at least one sidewall that makes an angle of greater than about 5° and less than about 40° with respect to the plane of the surface of the release liner. The method further includes removing the film and the adhesive layer under portions of the first surface not occupied by the image such that at least a portion of the surface of the release liner is exposed, attaching a handling tape to the image and the exposed portion of the release liner; and transferring the article into registration with a substrate. In an optional additional step, the handling film is removed from the substrate and the graphic article.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a cross-sectional view of a conventional adhesive-backed graphic article;

FIG. 2 is a perspective view of a release liner suitable for forming a structured surface in an adhesive layer;

FIG. 3 is a perspective view of a structured surface adhesive layer formed on the release liner of FIG. 2;

FIG. 4a is a perspective view of one embodiment of a protrusion on an adhesive layer according to the invention;

FIG. 4b is a perspective view of one embodiment of a truncated protrusion on an adhesive layer according to the invention;

FIG. 5 is a cross-sectional view along line A-A of FIG. 3 showing the dimensions of a protrusion on an adhesive layer according to the invention;

FIG. 6A is a cross-sectional view of a graphic article as it is initially contacted with a substrate;

FIG. 6B is a cross-sectional view of a graphic article after adequate adhesion to a substrate has been achieved;

FIG. 7 is a cross-sectional view of the adhesive backed article of FIG. 6 with portions of the film layer and adhesive layer cut away to expose the release liner; and

FIG. 8 is a cross-sectional view of the adhesive backed article of FIG. 7 with a second protective or transfer film applied thereto.

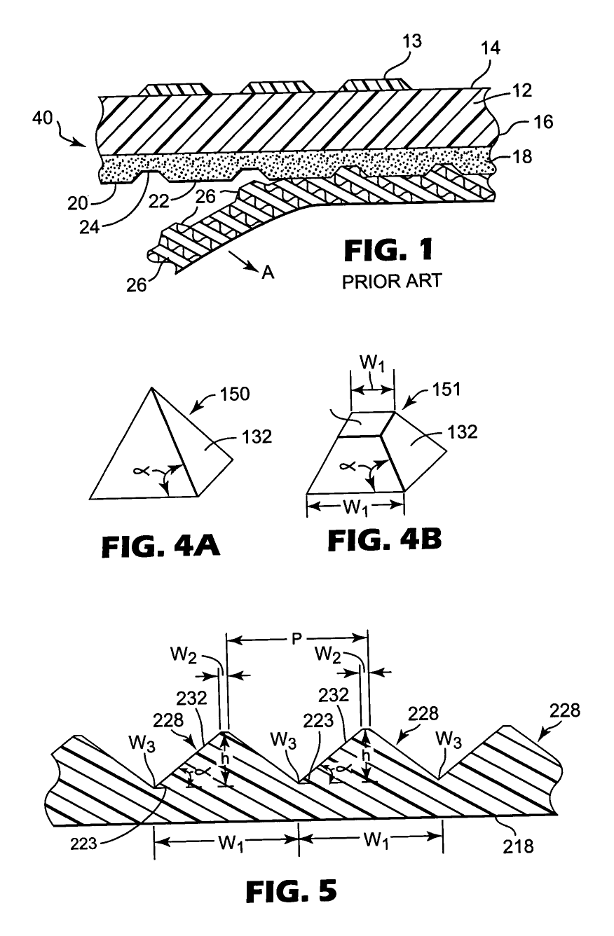

Like reference symbols in the various drawings indicate like elements.

### DETAILED DESCRIPTION

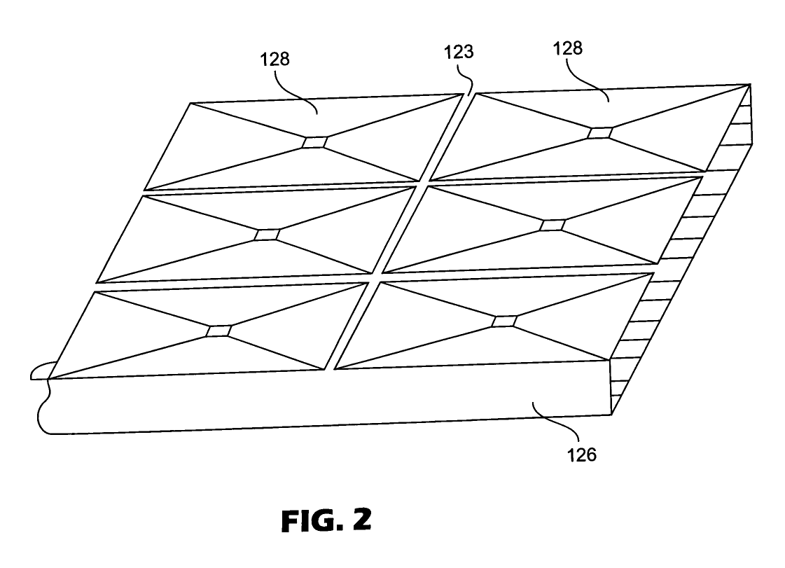

Referring to FIG. 2, a removable release liner 126 includes pyramidal depressions 128 that extend below a plane 123 of the release liner. The depressions 128 in the liner 126 may be made as described in WO 98/29516 and U.S. Pat. No. 5,650,215, which are incorporated herein by reference. The topography may be created in the liner 126 by any contacting technique, such as casting, coating or compressing. The topography may be made by at least one of: (1) casting the liner on a tool with an embossed pattern, (2) coating the liner onto a tool with an embossed pattern, or (3) passing the liner through a nip roll to compress the liner against a tool with an embossed pattern. The topography of the tool used to create the embossed pattern in the release liner 126 may be made using any known technique, such as, for example, chemical etching, mechanical etching, laser ablation, photolithography, stereolithography, micromachining, knurling, cutting or scoring.

The liner 126 may be any release liner or transfer liner known to those skilled in the art that is capable of being embossed as described above. The liner 126 should also be capable of being placed in intimate contact with a pressure sensitive adhesive and subsequently removed without damaging the adhesive layer. Non-limiting examples of liners include materials from Minnesota Mining & Manufacturing Company (3M) of St. Paul, Minn., Rexam Corporation of Iowa City, Iowa, or Daubert Coated Products of Westchester, Ill. The liner 126 is typically a polymer coated paper with a silicone release coating, a polyethylene coated polyethylene terepthalate (PET) film with silicone release coatings, or a cast polypropylene film with a silicone release coating. The liner 126 may also include structures designed to enhance the positionability of the adhesive article such as, for example, the glass beads in products available from 3M under the trade designation Controltac.

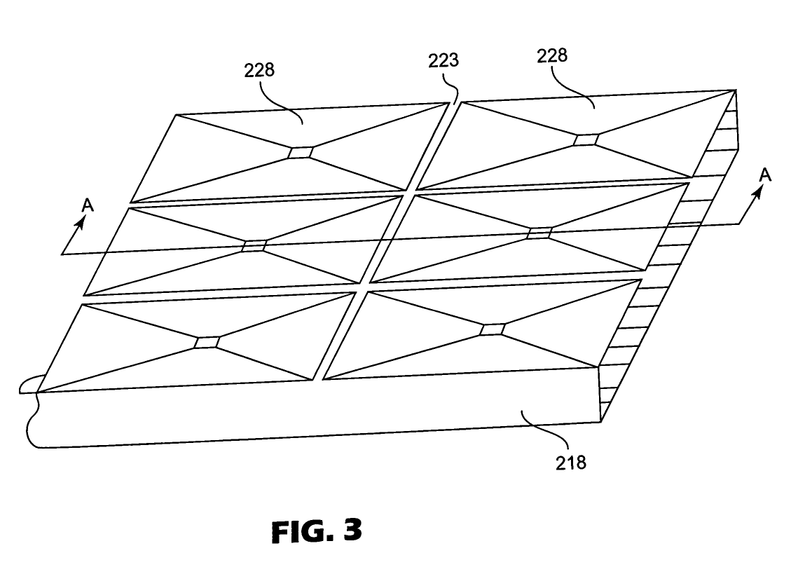

An adhesive layer may be coated and/or laminated on the embossed release liner 126 shown in FIG. 2. When the release liner 126 is removed, the surface of the adhesive layer has a topography that is essentially the reverse of the topography of the surface of the release liner 126. The resulting adhesive layer 218, which is shown in FIG. 3, includes pyramidal protrusions 228 corresponding to the pyramidal depressions 128 in the release liner 126. The pyramidal protrusions 228 extend upward from a plane 223 of the adhesive layer. The adhesive layer may optionally include additional non-adhesive structures such as, for example, those described in U.S. Pat. Nos. 5,296,277; 5,362,516; and 5,141,790. These non-adhesive structures are available from 3M. St. Paul, Minn., under the trade designation Controltac.

The pyramidal protrusions 228 on the adhesive layer 218 (and the corresponding depressions on the release liner 128) are preferably microscopic in at least two dimensions, i.e. the topical and/or cross-sectional view is microscopic. The term microscopic as used herein refers to dimensions that cannot be resolved by the human eye without aid of a microscope. The pyramidal protrusions/depressions may be present in either a random array or in regular patterns. Selected patterns could include rectilinear patterns, polar patterns and other conventional regular patterns.

The shape of the pyramidal protrusions 228 extending upward from a plane of the surface of the adhesive layer 218 (and the corresponding depressions 128 extending downward from the plane of the release liner 126) can vary widely depending on the intended application of the adhesive layer 218. Right pyramids, trigonal pyramids, square pyramids, and quadrangle pyramids are particularly preferred. The pyramidal structures may have pointed or truncated tops, and combinations of the different pyramidal shapes can be utilized.

In the release liner, the pyramidal depressions are capable of adhering to a handling tapes at rate of greater than about 10 g per 2 inch width, as measured by a Handling Tape to Liner Peel Adhesion Test described herein. Low tape to liner adhesions, for example less than 10 g /2 inch (5 cm) width, can result in the tape curling up off of the liner or falling off of the liner without extreme handling precautions.

In the adhesive layer, the pyramidal protrusions are capable of providing fluid egress of greater than about 20 ml/min, preferably greater than about 30 ml/min, at 23° C. under a pressure of 40 inches of water, and greater than about 10 ml/min, preferably greater than about 20 ml/min, at 35° C. under a pressure of 40 inches of water, as measured according to the Air Flow Test described herein. In the release liner 126, the pyramidal depressions are capable of adhering to a handling tape at a rate of greater than about 10 g per 2 inch width, preferably greater than about 20 g per 2 inch width, and most preferably greater than about 50 g per 2 inch width, as measured by a Handling Tape to Liner Peel Adhesion Test described herein.

FIG. 4A illustrates a quadrangle pyramid 150 as an illustration of one embodiment suitable for use as a protrusion 228 in the adhesive layer 218. FIG. 4B depicts a truncated quadrangle pyramid 151 that may also be used as a protrusion in the adhesive layer 218.

The protrusions 228 in the adhesive layer 218 (and the corresponding depressions in the release liner 126) are preferably arranged in a regular array. The regular array either terminates at the peripheral portion of the adhesive layer 218 (or the liner 126) or communicates with other structures that terminate at a peripheral portion thereof. The term regular array refers to a regular repeating pattern over at least a portion of the surface of the adhesive layer (or release liner), preferably over the entire surface.

As described in WO 98/295,116, incorporated herein by reference, the pyramidal protrusions 228 (See FIG. 3) should be sized according to the following general design considerations. First, the protrusions should preferably be sufficiently large to allow egress of fluids to the periphery of the adhesive layer for exhaustion into the surrounding atmosphere, but not so large as to allow ingress of unwanted fluids beneath the adhesive layer. Second, the protrusions 228 should also not be so large as to detract from the appearance of an exposed surface of a film adhered to the adhesive layer, particularly if the film is to be imaged. Third, the protrusions 228 should not be so large as to detract from the adhesive bonding performance of the adhesive layer.

Referring to FIG. 5, a section of the adhesive layer 218 along line A-A (FIG. 3) is shown that includes a plurality of protrusions 228 extending above the plane 223 of the adhesive layer. The dimensions of the protrusions may vary widely depending on the intended application of the adhesive layer and the release liner, and should be selected to provide adequate balance between adhesion to substrate, fluid egress, and adhesion of the corresponding depressions in the release liner to handling tapes. The pitch P between the protrusion 228 may be up to about 400 μm, preferably about 150 μm to about 350 μm. The height h of each protrusion 228 from a plane 223 of the adhesive layer 218 is preferably greater than about 15 μm and up to about 35 μm, more preferably about 17 μm to about 30 μm. The width W₁ of the protrusion 228 at its base is typically greater than about 150 μm. The distance W₂ may vary widely depending on the balance of adhesion to substrate, fluid egress and release liner handling tape adhesion, and should typically be less than about 50% of the width of the base W₁. Preferably, W₂ is about 0 μm (pointed top) to about 20 μm (truncated), more preferably about 2 μm to about 5 μm. The gap W₃ between the pyramidal protrusions 228 is preferably about 0 μm to about 10 μm, more preferably about 2 μm to about 6 μm. The protrusions 228 have at least one sidewall 232 that makes an angle a with respect to a plane 223 of the surface of the adhesive layer 218. The angle α is preferably selected from an angle greater than about 5° and less than about 40°, more preferably about 10° to about 17°.

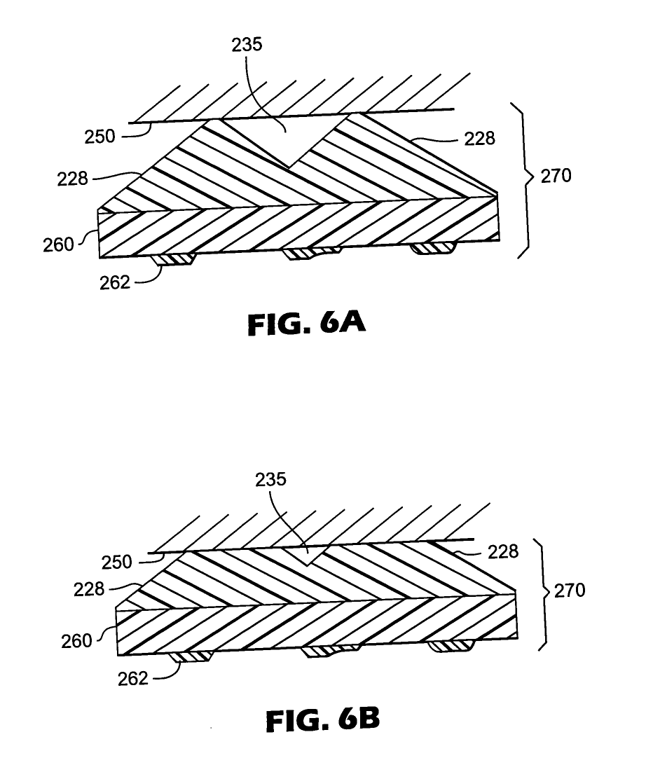

Referring to FIGS. 6A and 6B, once the release liner 126 (not shown in FIG. 6) is removed, the exposed surface of the structured adhesive layer 218 may be adhered to a variety of substrates 250. The surface of the adhesive layer opposite the structured surface typically includes a film layer 260, which includes an image layer 262. Referring to FIG. 6A, as the adhesive layer 218 is initially contacted with the substrate 250, the pyramidal protrusions 228 contact the surface of the substrate, and the areas 235 between the protrusions 228 function as channels for fluid egress. This allows pockets of trapped air between the adhesive layer and the substrate to be easily removed. Referring to FIG. 6B, after adequate application consistent with techniques known in the art, increase adhesive wet-out will occur and the areas 235 will decrease in size or disappear completely. Examples of suitable substrates 250 include glass, metal, plastic, wood, and ceramic substrates, painted surfaces of these substrates, imaged films, sign faces, and the like. Representative plastic substrates include polyvinyl chloride, ethylene-propylene-diene monomer rubber, polyurethanes, polymethyl methacrylate, engineering thermoplastics (e.g., polyphenylene oxide, polyetheretherketone, polycarbonate), and thermoplastic elastomers.

Referring again to FIG. 6, the film 260 may vary widely depending on the intended application, and may be made of a wide variety of materials such as, for example, polymers, metal foils, metal plates, ceramic plates, foamed sheets, and reflective sheeting. The film 260 is preferably made of a polymeric material used conventionally by those skilled in the art. Suitable polymeric films include, for example, vinyl, polyvinyl chloride, plasticized polyvinyl chloride, polyurethane, polyethylene, polypropylene, fluororesin and the like. The thickness of the film 260 can vary widely according to a desired application, but is usually about 300 μm or less, and preferably about 25 μm to about 100 μm.

Any pressure-sensitive adhesive is suitable for the adhesive layer 218. Classes of pressure-sensitive adhesives include acrylics, tackified rubber, tackified synthetic rubber, ethylene vinyl acetate, silicone, and the like. Suitable acrylic adhesives are disclosed, for example, in U.S. Pat. Nos. 3,239,478, 3,935,338, 5,169,727, Pat. No. RE 24,906, U.S. Pat. Nos. 4,952,650, and 4,181,752. A suitable class of pressure-sensitive adhesives is the reaction product of at least one alkyl acrylate with at least one reinforcing comonomer. Suitable alkyl acrylates are those having a homopolymer glass transition temperature below about −10° C. and include, for example, n-butyl acrylate, 2-ethylhexylacrylate, isoctylacrylate, isononyl acrylate, octadecyl acrylate and the like. Suitable reinforcing monomers include, for example, acrylic acid, itaconic acid, isobornyl acrylate, N,N-dimethylacrylamide, N-vinyl caprolactam, N-vinyl pyrrolidone, and the like.

The adhesive composition and rheology of the adhesive layer 218 should be selected to provide the desired degree of wet-out between the adhesive layer 218 and the substrate 250, as well as the retention of the fluid egress channels 235. The adhesives may be polymers that are dispersed in solvent or water and coated onto the release liner and dried, and optionally crosslinked. If a solvent borne or water borne pressure-sensitive adhesive composition is employed, then the adhesive layer may undergo a drying step to remove all or a majority of the carrier liquid. Additional coating steps may be necessary to achieve a smooth surface. The adhesives may also be hot melt coated onto the liner or microstructured backing. Additionally, monomeric pre-adhesive compositions can be coated onto the liner and polymerized with an energy source such as heat, UV radiation, e-beam radiation, and the like. The thickness of the adhesive may vary widely depending on the intended application, and typically ranges from about 10 μm to about 50 μm.

The pressure sensitive adhesive can optionally include one or more additives such as, for example, initiators, fillers, plasticizers, tackifiers, chain transfer agents, fibrous reinforcing agents, woven and non-woven fabrics, foaming agents, antioxidants, stabilizers, fire retardants, viscosity enhancing agents, coloring agents, and mixtures thereof.

Referring to FIG. 7, a graphic article 370 is shown that includes a graphic 362 imaged on a first surface 314 of a film layer 360. A second surface 316 of the film layer 360 lies adjacent to the structured adhesive layer 318. The adhesive layer 318 includes pyramidal protrusions 328. The adhesive layer 318 is protected by a removable structured release liner 316, which includes depressions 329 corresponding to the protrusions 328. In FIG. 7, the film layer 362 and the adhesive layer 318 have been carefully cut away around the graphic 362. The area of the film 362 and adhesive 318 not overlain by the graphic 362 have been removed to expose a portion 330 of the structured surface of the release liner 326.

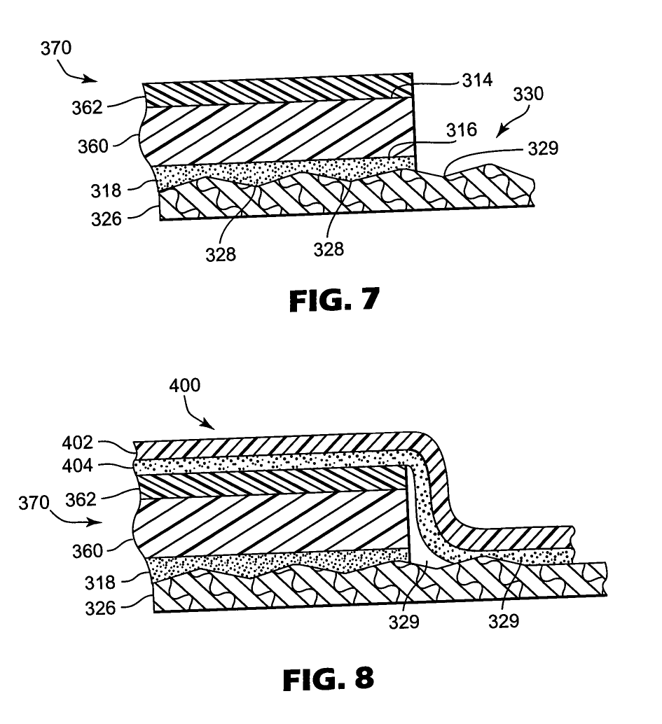

As shown in FIG. 8, once the film and adhesive not overlain by the graphic 362 are removed, a second tape 400 may be applied over the graphic 362 and/or the release liner 326. The tape 400 may be used to protect the graphic 362 from damage during handling, or may be a pre-mask or pre-space tape to facilitate transfer and registration of the construction 370 with respect to a substrate. The tape 400 may also be a splicing tape used to temporarily join the release liner 326 to another release liner (not shown in FIG. 8). Generally, the tape 400 includes a film layer 402 and an adhesive layer 404. The tape 400 may also include other layers depending on its intended function, and these layers will not be detailed here. When the tape 400 contacts the release liner 326, the film layer 402 is typically sufficiently stiff that the tape adhesive layer 404 cannot completely conform to the topography of the release liner 326. This results in insufficient adhesion between the tape 400 and the release liner 326. The shape and spacing of the depressions 329 in the release liner 326 are selected to enhance adhesion between the release liner 326 and the handling tape 400.

The invention will now be described with reference to the following non-limiting examples.

### EXAMPLES

Sample Analyses:

Liner and adhesive samples were evaluated using light microscopy with a JENA JENAVERT (Jena, Germany) incident light microscope or Bausch and Lomb stereo microscope (Bausch & Lomb, Rochester, N.Y.), or interferometry microscopy using a WYKO RST surface profiler (WYKO Corp., Tucson, Ariz.).

Tests:

Handling Tape to Liner Peel Adhesion Test: Two inch wide strips of 3M SCPS-55 application tape are adhered to the release or microstructured face of the liners by lamination at 60 psi using a roll laminator (Robert L. Greig, Inc.) having 3 inch (7.6 cm) diameter by 32 inch (81 cm) wide 60 D durometer rollers and ⅝″ (1.6 cm) diameter rams. After one hour dwell in a constant temperature and humidity room at 22° C. and 50% relative humidity, the tapes are peeled at a constant 180° angle from the laminated samples using an IMASS adhesion tester set for a rate of 90 inches/minute. The tape to liner adhesion measurement may be reported in grams per inch width or grams per two inch width.

Graphic to Substrate Peel Adhesion Test: Adhesion tests of the graphics to substrates are a modification of ASTM method D3330 (1992) and Pressure Sensitive Tape Council method PSTC-1 (1989). Painted aluminum test panels (Fruehauf, Indianapolis, Ind.) are cleaned with a solvent available from E.I. DuPont de Nemours, Wilmington, Del., under the trade designation PrepSol, and allowed to dry. Samples of pressure sensitive adhesive and film on liner are cut into 2.54 cm wide strips. The release liner is removed, and the strips are applied to the panels using a PA-1 Hand Applicator (available from 3M, St. Paul Minn.) with an applied mass of 450 grams at a speed of about 2.5 centimeter/second. A backing strip of 2.54 cm wide adhesive film available from 3M under the trade designation Scotchcal Series 3650 is laminated in registration onto each sample strip. The backing film prevents the sample films and pressure sensitive adhesive from excessively stretching during peel back testing. After 24 hours in a constant temperature and humidity room (CTH) at 22° C. and 50% relative humidity or after 7 days at 66° C. followed by 24 hour equilibration in the constant temperature and humidity room, peel adhesion is measured as a 90° peel back at a crosshead speed of 30.5 centimeters per minute using a Instron 5564 tensile tester (Instron Corp., Canton, Mass.).

Indent Panel Test: A circular indent is made in 0.7 mm thick aluminum test panel using a hemispherical drop hammer with a tip diameter of 2.5 cm. For the panel used, the indent was about 2.8 cm diameter at the plane of the panel and was about 0.6 cm deep. A 7.5 cm by 7.5 cm test sample to be tested is centered over the indent and applied flat onto the panel and taut over the indent. A PA-1 Hand Applicator with a protective sleeve (SA-1, available from 3M) is used to press the sample onto the panel using a mass of about 1 kg. Then the film is pressed with a thumb into the depressed indent. At least 3 kg of mass is applied. The ability of the sample to conform into the indent and uniformly contact the depressed panel indent is rated as follows:

0 sample would not conform significantly into the indent against the entrapped air

1 sample could be pressed down into the indent to the extent of about 50%

2 sample could be pressed down to conform with much of the indent leaving small air bubbles

3 sample could be pressed down to conform slowly (greater than 5 seconds) and completely into indent

4 sample could be pressed down to conform swiftly (less than 5 seconds) and completely into the indent

Samples having flat or finely roughened pressure sensitive adhesive surfaces typically have a rating of 0.

Rivet Panel Test: A test sample is manually pressed over a 12 mm diameter by 2.5 mm high rounded rivet onto a riveted Fruehauf flat panel by starting at the edges of the sample 3.8 cm from the center of the rivet. The sample is pressed down, using both thumbs, with thumb pressure (approximately 750 g for each thumb) at the periphery using a circular motion to entrap a large air pocket under the film. The film is then pressed in at the edge of the air pocket towards the rivet keeping thumbs at opposite sides of the rivet and making half-circular motions in alternating directions with decreasing radii to keep the thumbs along the margin of the pocket (approximately 750 g for each thumb). The force is limited so as not to burst the film. This procedure ensures that a large air pocket is formed under the sample and is prevented from being pushed under the film, to the sample edge, by de-bonding of the pressure sensitive adhesive. The time required for dissipating the air pocket and conforming the film to within 2 mm of the rivet is determined. If a large air pocket remains after 5 minutes of working the film, the diameter of the air pocket is determined. A range may be reported for repeat testing. Samples with best air dissipation generally require less than about 30 to 60 seconds to conform the film up to the rivet. Samples requiring greater than 2 minutes up to 5 minutes to conform the film up to the rivet generally have air flow that may be too restricted for some applications. Poorest samples entrap about a 35 mm (or larger) air pocket after 5 minutes of working application. Samples having flat or finely roughened pressure sensitive adhesive surfaces typically leave a large air pocket.

Hot Application/Reapplication Test: A horizontal glass plate is heated to 40-43° C. and cleaned with methyl ethyl ketone (MEK). A piece of the pressure sensitive adhesive sheet to be tested, approximately 2.5 cm by 7.5 cm, is draped flat onto the glass plate with the pressure sensitive adhesive side down for approximately 10 seconds, and the edges are pressed with a finger with approximately 500 g “force” to uniformly contact the periphery (from the edge to about 0.5 cm inward) to the glass plate. The sample is then pressed by a finger around the periphery and toward the center of the sample to prevent the PSA from debonding and prevent the entire air pocket from moving to the edge of the sample. The sample applied in this fashion is then evaluated for presence or absence of trapped bubbles. The strip is slowly peeled off of the stage and reapplied in the same procedure. A third reapplication is also done. The test ratings are as follows:

0 sample showed trapped bubbles after the first application (indicating no detectable air release properties)

1 sample did not show bubbles after the first application, but did show after either the second or third reapplication

2 sample did not show bubbles after the second application, but did show after the third reapplication

3 no bubbles were observed on any of the three application and reapplications (showing air release properties for the first application and showing retention of air release properties for the subsequent reapplications). Also, the channels in the pressure sensitive adhesive layer may still be present even after the third removal step.

Materials having a rating of 3 are considered to be excellent. Materials having a rating of 0 are considered to be poor. Materials having a rating of 1 show air bleed that are too low for consistent applications and reapplications onto surfaces at elevated temperatures. Samples having flat or finely roughened pressure sensitive adhesive surfaces typically have a rating of 0.

Air Flow Test

The ability of a structured article to provide air bleed (also referred to as air flow) after application to a substrate is measured in the following manner. The test fixture is a stainless steel substrate having machined therein two circular concentric channels, one inside the other. The two circles have a radius of 2.0 inches (5.1 cm) and 2.5 inches (6.4 cm) respectively, and the channels of each are 0.030 inches (0.76 mm) wide and 0.060 inches (1.52 mm) deep. Each channel has a pair of openings, measuring 0.03 inches (0.76 mm) in diameter and spaced about 0.25 inches (0.64 cm) apart from each other. The openings in the inner channel are connected to a pressure source and the openings in the outer groove/channel are connected to an air flow measurement device. A sample is applied to cover the concentric grooves using a 3 inch wide, 2.4 inch diameter, 1235 g rubber roller with a hardness of 60 A durometer. A pressure of 0-100 inches of water is applied to the inner channel through the openings therein and the flow of air out through the openings in the outer channel is measured. The air flow is reported in milliliters/minute.

Percent Wetout and Channel Sealing Test:

A sample of the pressure sensitive adhesive sheet is carefully laid, adhesive side down, onto a clear, smooth, flat acrylic panel. A felt pad attached to the end of a handle is used to apply pressure to the surface of the sample. The sample area is larger than the felt pad. The felt pad has a 15 mm radius. The handle is held by hand, and the pad is pressed onto the sample surface in the same spot using a force of 497 g for 10 seconds. The wetout area of the adhesive is determined using microscopy. The extent of channel sealing is also determined by microscopy.

### Examples 1 to 5 and Comparative Examples C1 to C6

Release liners were microembossed to form patterns of recessed cells on the front side surface. The liners generally had a 125 micron paper core, a 25 micron polyethylene coating with a matte finish on the back side, a 25 micron polyethylene coating with a glossy finish on the front side, and a commercial silicone coating on the glossy polyethylene side. Each set of patterns was formed under heat and pressure using an engraved embossing tool. Each engraved pattern was an array of regularly spaced inverted square pyramidal cells with the walls of the cells oriented at a 45° bias to the vertical direction of the web. Table 1 shows the dimensions of each pattern for Examples 1-5 and Comparative Examples C1 to C4.

Other comparative examples C5 and C6 had patterns of continuous intersecting parallel raised ridges in grids oriented at a 45° bias to the direction of the web. The slopes of the sidewalls of the ridges were about 54°. The cross-sections of the ridges were trapezoids. The trapezoidal ridges of Example C5 had a base width of about 43 microns, a top width of about 11 microns, and a height of about 22 microns. The pitch was about 290 microns. The trapezoidal ridges of Example C6 had a base width of about 41 microns, a top width of about 12 microns, and a height of about 20 microns. The pitch was about 203 microns.

The patterns of all of the samples were virtually undetectable when viewed at a distance of 10 inches (25 cm) with the unaided eye.

TABLE 1

| | | Nominal | | | |
|---|---|---|---|---|---|
| | | Sidewall | Pitch | Gap between | |
| | Height | from | (repeat | pyramidal | Tops of |
| | (depth) | plane | distance) | structures | pyramids |
| Example | (microns) | (degrees) | (microns) | (microns) | (microns) |
| C1 | 10 | 15 | 82.7 | 6 | 2 |
| C2 | 10 | 40 | 31.8 | 6 | 2 |
| C3 | 15 | 8.5 | 197 | 0 | 0 |
| C4 | 15 | 27.5 | 65.6 | 6 | 2 |
| 1 | 20 | 15 | 157 | 6 | 2 |
| 2 | 20 | 40 | 55.7 | 6 | 2 |
| 3 | 25 | 10 | 292 | 6 | 2 |
| 4 | 25 | 15 | 195 | 6 | 2 |
| 5 | 25 | 20 | 145 | 6 | 2 |

### Examples 6-10 and Comparative Examples C7-C12

An acrylic pressure sensitive adhesive solution (described as Adhesive Solution 1 in U.S. Pat. No. 5,296,277) was modified with 18.5 phr of a resin available under the trade designation Nirez 2019 from Arizona Chemical Co. The adhesive solution was coated onto the release liners of Examples 1-5 and C1-C6 and dried at 66° C. for 10 minutes to form an adhesive film about 32 microns thick. The exposed adhesive side of these samples were laminated at room temperature to a 46 micron thick plasticized, white flexible and conformable vinyl (PVC) film identical to that used in film constructions available from 3M under the trade designation Controltac Plus Graphic Marking Film Series 180-10. The lamination used a Vanquisher roll laminator (Stoughton Machine and Manufacturing Co., Inc., Stoughton Wis.) at 200 kPa (30 psi) gauge pressure and a speed of about 2.5 cm/second to afford an essentially flat construction. Removal of the liner exposed essentially an inverse topography in the continuous adhesive layer. The topography was regularly spaced raised square pyramidal protrusions.

The patterns of all of the samples were virtually undetectable when viewed at a distance of 10 inches with the unaided eye.

The adhesive-backed films were evaluated using the Indent Panel Test, the Rivet Panel Test, the Hot Application/Reapplication Test, and the Air Flow Test. The Air Flow Test was run at 23° and at 35° C. with an air pressure of 40 inches of water. The liners were subjected to the Tape to Liner Peel Adhesion Test. The results are tabulated in Table 2. The results showed a range of application and air bleed performance for the graphics and a range of adhesions of handling tape to liner. The examples show that the best results for all tests are achieved only within a range of a combination of pyramid heights (depths) and sidewall slopes. Of the samples prepared, samples that tested for poorer application air bleed properties had pyramid heights of about 10 microns with sidewall angles ranging from 15 to 40 degrees or pyramid heights of about 15 microns with a sidewall slope of less than about 10 degrees. Handling tape adhesion to the liners having the pyramidal features improved with lower sidewall slopes and lower depths of the pyramidal depressions.

TABLE 2

| | | Handling | | | Hot | | |
|---|---|---|---|---|---|---|---|
| | | Tape to | | | Appli- | | |
| | Liner | Liner Peel | | | cation/Re- | Air | Air |
| | Sample | Adhesion | Indent | | appli- | Flow | Flow |
| | (Example | Test (g/2″ | Panel | Rivet Panel | cation | Test at | Test at |
| Example | number) | width) | Test | Test | Test | 23° C. | 35° C. |
| C7 | C1 | 70 | 1 | 37 mm air pocket | 0 | 3 | 0 |
| | | | | after 5 minutes | | | |
| C8 | C2 | 40 | 1 | 34 mm after 5 | 0 | 18 | 2 |
| | | | | minutes | | | |
| C9 | C3 | 68 | 0-1 | 138 seconds on one | 1 | 8-13 | 2 |
| | | | | try, 35 mm air pocket | | | |
| | | | | entrapped after 5 | | | |
| | | | | min. on another try | | | |
| C10 | C4 | 15 | 1 | 140 seconds | 1 | 35 | 8 |
| C11 | C5 | 0 | 4 | 15 | 3 | 49 | — |
| C12 | C6 | 4 | 4 | 12 | 3 | >102 | — |
| 6 | 1 | 55 | 3 | 26-30 seconds | 3 | 88 | 25 |
| 7 | 2 | 16 | 2 | 65 seconds | 3 | 96 | 28 |
| 8 | 3 | 70 | 4 | 13-20 seconds | 3 | 81 | 32 |
| 9 | 4 | 21 | 4 | 13-15 seconds | 3 | 102 | 42 |
| 10 | 5 | 11 | 4 | 15 seconds | 3 | 102 | 43 |

### Example 11

A release liner having a structure similar to the liner of Example 1, but having a spacing of about 7 microns, a flat top of about 9-12 microns or more, a pitch of 190 microns and an approximate aspect ratio of 8.6 was prepared by microembossing. That liner and the liners of Comparative Examples C3, C5, and C6 were coated at speeds of 80 to 120 fpm using the adhesive of Examples 13-23. The liners of Example 1 and comparative Example C3 coated smoothly with little or no air bubbles entrapped or formed in the coating process.

The coating of liners of comparative Examples C5 and C6 formed many entrapped air bubbles in the adhesive layer resulting in a bumpy adhesive surface.

### Examples 12-14 and Comparative Example C13

The samples of Examples 3, 4, and 5 were tested using the Graphic to Substrate Peel Adhesion Test.

An additional comparative sample C13 was prepared as in Examples 6-10 using a liner having a pattern of continuous intersecting parallel raised ridges in grids oriented at a 45° bias to the direction of the web. The slopes of the sidewalls of the ridges near the plane of the liner were about 90°. The ridges had a rounded cross-section shape with base width of about 90 microns and a height of at least 25 microns. The pitch was 1270 microns.

Table 3 shows that the constructions of the current invention show good bonding properties.

TABLE 3

| | Sample | Peel Adhesion | Peel Adhesion |
|---|---|---|---|
| Exam- | (Example | after 24 hours CTH | after 7 days 66° C. |
| ple | number) | dwell (lb/in) | dwell (lb/in) |
| 12 | 3 | 1.8 | 3.9 |
| 13 | 4 | 1.8 | 4.2 |
| 14 | 5 | 1.9 | 4.5 |
| C13 | | 2.0 | 3.2 |

### Example 15-17 and Comparative Example C14

Samples of Examples 8, 9, and 10 and Comparative Example C9 were tested with the Percent Wetout Test. Table 4 shows the results. The comparative example showed more wetout under the test conditions and sealing of the channel pathways that are needed for sufficient fluid exhaust during application processes.

TABLE 4

| | Sample | % | Fluid Exhaust |
|---|---|---|---|
| Example | (Example number) | Wetout | Channels sealed |
| C14 | C9 | 90 | Yes |
| 15 | 8 | 62 | No |
| 16 | 9 | 58 | No |
| 17 | 10 | 64 | No |

A number of embodiments of the invention have been described. Nevertheless, it will be understood that various modifications may be made without departing from the spirit and scope of the invention. Accordingly, other embodiments are within the scope of the following claims.

What is claimed is:

1. A release liner with a surface comprising an array of pyramidal depressions thereon, wherein the depressions are capable of adhering to a handling tape at rate of greater than about 10 g per 2 inch width, as measured by a Handling Tape to Liner Peel Adhesion Test.

2. The release liner of claim 1, wherein the depressions extend downward from a plane of the surface of the release liner to a depth of greater than 15 microns and less than 35 microns, and wherein the structures have at least one sidewall that makes an angle with respect to the plane of the surface of greater than 5° and less than 40°.

3. The release liner of claim 2, wherein the at least one sidewall makes an angle of 10° to 40° with respect to the plane of the surface.

4. The release liner of claim 2, wherein the at least one sidewall makes an angle of about 10° to about 17° with respect to the plane of the surface.

5. The release liner of claim 2, wherein the depressions are truncated.

6. The release liner of claim 2, wherein the depressions have a depth of greater than 20 microns.

7. The release liner of claim 2, wherein the depressions are separated by a gap of about 0 microns to about 10 microns.

8. The release liner of claim 2, wherein the depressions are separated by a gap of about 5 microns to about 10 microns.

9. The release liner of claim 2, wherein the depressions form a substantially regular pattern on the surface.

10. The release liner of claim 2, wherein the depressions have a pitch of up to about 400 microns.

11. An adhesive backed article, comprising:
(a) a release liner with a surface comprising pyramidal depressions, wherein the depressions extend downward from a plane of the surface of the release liner to a depth of greater than 15 microns and less than 35 microns, and wherein the depressions have at least one sidewall that makes an angle of greater than about 5° and less than about 40° with respect to the plane of the surface; and
(b) an adhesive layer on the surface of the release liner.

12. The adhesive backed article of claim 11, wherein the adhesive layer is capable of providing fluid egress of greater than about 20 ml/min at 23° C. under a pressure of 40 inches of water, and greater than about 10 ml/min at 35° C. under a pressure of 40 inches of water, as measured according to the Air Flow Test.

13. An adhesive layer with an array of pyramidal protrusions thereon, wherein the adhesive layer is capable of providing fluid egress of greater than about 20 ml/min at 23° C. at a pressure of 40 inches of water, as measured according to the Air Flow Test.

14. The adhesive layer of claim 13, wherein the adhesive layer is capable of providing fluid egress of greater than about 10 ml/min at 35° C. at a pressure of 40 inches of water, as measured according to the Air Flow Test.

15. The adhesive layer of claim 13, wherein the protrusions extend upward from a plane of the surface of the adhesive layer to a height of greater than 15 microns and less than 35 microns, and wherein the protrusions preferably have at least one sidewall that makes an angle of greater than 5° and less than 40° with respect to the plane of the surface.

16. A graphic article comprising:
(a) an adhesive layer with a surface comprising pyramidal protrusions, wherein the protrusions extend upward from a plane of the surface to a height of greater than 15 microns and less than 35 microns, and the protrusions have at least one sidewall that makes an angle of greater than 5° and less than 40° with respect to the plane of the surface; and
(b) an imageable film on a surface of the adhesive layer.

17. The graphic article of claim 16, further comprising a release liner on a surface of the adhesive layer opposite the film.

18. A method comprising:
(a) providing a graphic article having an adhesive layer with a surface comprising pyramidal protrusions, wherein the protrusions extend upward from a plane of the surface to a height of greater than 15 microns and less than 35 microns, and wherein the protrusions have at least one sidewall that makes an angle of greater than 5° and less than 40° with respect to the plane of the surface; and an imageable film on a surface of the adhesive layer; and
(b) contacting the adhesive layer with a substrate.

19. A method of enhancing the adhesion of a tape to a release liner, comprising adhering the tape to a surface of a release liner comprising pyramidal depressions, wherein the depressions extend downward from a plane of the surface of the release liner to a depth of greater than 15 microns and less than 35 microns, and wherein the depressions have at least one sidewall that makes an angle of greater than about 5° and less than about 40° with respect to the plane of the surface.

20. A method of transferring an adhesive backed article with a release liner and an adhesive layer on the release liner, comprising attaching a tape to the release liner, wherein the release liner has a surface with pyramidal depressions thereon, the depressions extend downward from a plane of the surface of the release liner to a depth of greater than 15 microns and less than 35 microns, and have at least one sidewall that makes an angle of greater than about 5° and less than about 40° with respect to the plane of the surface.

21. A method of transferring a graphic article, comprising:
(a) providing a graphic article including a film with a first surface and a second surface, wherein an image occupies at least a portion of the first surface, an adhesive layer on the second surface of the film, and a release liner on the adhesive layer, wherein the release liner has a surface with pyramidal depressions thereon, said depressions extend downward from a plane of the surface of the release liner to a depth of greater than 15 microns and less than 35 microns, and said depressions have at least one sidewall that makes an angle of greater than about 5° and less than about 40° with respect to the plane of the surface of the release liner;
(b) removing the film and the adhesive layer under portions of the first surface not occupied by the image such that at least a portion of the surface of the release liner is exposed;
(c) attaching a handling tape to the image and the exposed portion of the release liner; and
(d) transferring the article into registration with a substrate.

22. The method of claim 21, wherein the handling film is selected from a pre-mask film, a pre-space film and a splicing film.

23. The method of claim 21, wherein the depressions form a substantially regular array on the surface.

24. The method of claim 21, further comprising the step of removing the handling film from the substrate and the graphic article.
